(19) United States
(12) Patent Application Publication
(10) Pub. No.: US 2025/0334990 A1
(43) Pub. Date: Oct. 30, 2025

(54) Device and Method for Generating a Temperature-Independent Reference Voltage

(71) Applicant: Taiwan Semiconductor Manufacturing Company, Ltd., Hsinchu (TW)

(72) Inventors: Wei-Lin Lai, Hsinchu (TW); Bei-Shing Lien, Hsinchu (TW); Szu-Lin Liu, Hsinchu (TW)

(21) Appl. No.: 18/645,608

(22) Filed: Apr. 25, 2024

(51) Int. Cl. G05F 3/26

(52) U.S. Cl. CPC G05F 3/262

(57) ABSTRACT

A voltage generator includes a temperature-dependent voltage generator and a reference voltage node. The temperature-dependent voltage generator generates a voltage that increases with temperature and includes a first transistor stack and a second transistor stack. Each of the first transistor stack and the second transistor stack has a predetermined number of transistors. The number of the transistors of the second transistor stack is greater than the number of the transistors of the first transistor stack. The reference voltage node is connected to the temperature-dependent voltage generator and provides a reference voltage substantially independent of temperature. A method for generating the temperature-independent reference voltage is also disclosed.

### BACKGROUND

A reference voltage that remains constant regardless of changes in temperature is desirable in many devices, where a stable voltage enables most accurate operations. If a reference voltage were to vary with temperature, it could introduce errors or instability in the device's performance. Having a temperature-independent reference voltage can enable more consistent and reliable operation of the device across different environmental conditions. Such a reference voltage can help maintain accuracy and stability in various applications, such as analog-to-digital converters, voltage regulators, sensor interfaces, and other circuitry where precise voltage references are beneficial.

### BRIEF DESCRIPTION OF THE DRAWINGS

Aspects of the present disclosure are best understood from the following detailed description when read with the accompanying figures:

FIG. 1 is a schematic block diagram illustrating an exemplary semiconductor device in accordance with various embodiments of the present disclosure;

FIG. 2 is a schematic circuit diagram illustrating another exemplary semiconductor device in accordance with various embodiments of the present disclosure;

FIG. 3 is a schematic circuit diagram illustrating an exemplary transistor module of a semiconductor device in accordance with various embodiments of the present disclosure;

FIG. 4 is a schematic circuit diagram illustrating another exemplary transistor module of a semiconductor device in accordance with various embodiments of the present disclosure;

FIG. 5 is a schematic circuit diagram illustrating another exemplary transistor module of a semiconductor device in accordance with various embodiments of the present disclosure;

FIG. 6 is a schematic circuit diagram illustrating another exemplary transistor module of a semiconductor device in accordance with various embodiments of the present disclosure;

FIG. 7 is a schematic circuit diagram illustrating another exemplary transistor module of a semiconductor device in accordance with various embodiments of the present disclosure;

FIG. 8 is a schematic circuit diagram illustrating another exemplary transistor module of a semiconductor device in accordance with various embodiments of the present disclosure;

FIG. 9 is a schematic circuit diagram illustrating another exemplary transistor module of a semiconductor device in accordance with various embodiments of the present disclosure;

FIG. 10 is a schematic circuit diagram illustrating another semiconductor device in accordance with various embodiments of the present disclosure;

FIG. 11 is a schematic circuit diagram illustrating another semiconductor device in accordance with various embodiments of the present disclosure; and

FIG. 12 is a flow chart illustrating an exemplary method for generating a temperature-independent reference voltage in accordance with various embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A reference voltage that has a zero (or near zero) temperature coefficient or that is independent of temperature is advantageous for devices that benefit from a stable voltage, as that reference voltage remains constant despite temperature changes. This can assist in providing accuracy and stability in various devices like analog-to-digital converters, voltage regulators, and sensor interfaces. A temperature-independent reference voltage may be generated using a temperature-dependent voltage generator that generates a voltage that is dependent of, i.e., that can vary with, temperature. In some instances, the temperature-dependent voltage may be a proportional to absolute temperature (PTAT) voltage that has a positive temperature coefficient and that increases with increasing temperature or a complementary to absolute temperature (CTAT) voltage that has a negative temperature coefficient and that decreases as temperature rises. In some instances, temperature-dependent voltage generators are implemented with bipolar junction transistors (BJTs) and/or a combination of transistors having different voltage thresholds, e.g., standard voltage threshold (SVT), low voltage threshold (LVT), high voltage threshold (HVT), ultra-low voltage threshold (ULVT), ultra-high voltage threshold (UHVT). Implementations where a combination of differing transistors are used can result in inconsistent performance, i.e., in a 3-sigma accuracy of 10% to 15%.

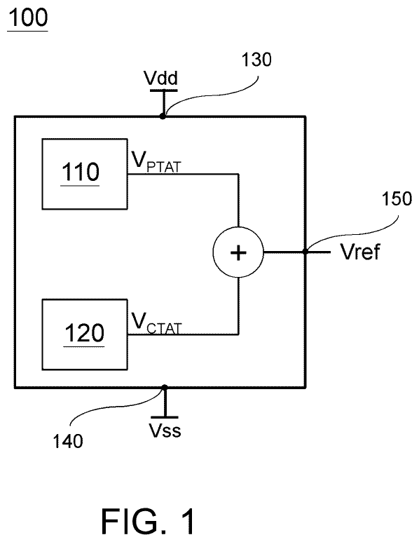

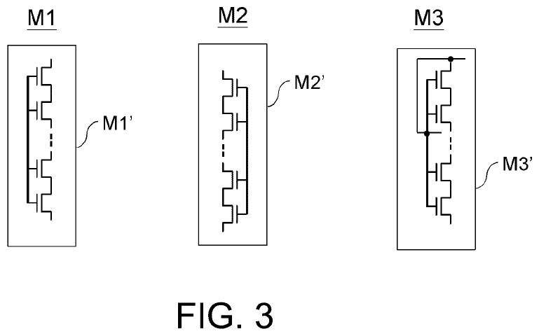

Systems and methods as described in certain examples herein include a temperature-dependent voltage generator, e.g., temperature-dependent voltage generator 110 of FIG. 1, implemented with transistors, e.g., field-effect transistors (FET), having substantially the same voltage threshold and without using BJTs, and temperature-independent voltage generators based thereon, which can result in a 3-sigma accuracy of less than 5%. For example, the temperature-dependent voltage generator 110 comprises one or more transistor stacks, e.g., transistor stack (M1′) of FIG. 3 in accordance with an embodiment, each having a predetermined number of transistors connected in series. In further detail, FIG. 1 is a schematic block diagram illustrating an exemplary semiconductor device 100 in accordance with various embodiments of the present disclosure.

As illustrated in FIG. 1, the semiconductor device 100, e.g., a voltage generator, is in the form of a bandgap circuit and includes a first temperature-dependent voltage generator 110 and a second temperature-dependent voltage generator 120. The semiconductor device 100 is connected across a first supply voltage node 130 that receives a first supply voltage (Vdd) and a second supply voltage node 140, e.g., an electrical ground, that receives a second supply voltage (Vss), e.g., 0 Volts, lower than the first supply voltage (Vdd).

The first temperature-dependent voltage generator 110 includes a proportional to absolute temperature (PTAT) circuit and generates a PTAT voltage (V_{PTAT}) that has a positive temperature coefficient and that increases with temperature. The second temperature-dependent voltage generator 120 includes a complementary to absolute temperature (CTAT) circuit and generates a CTAT voltage (V_{CTAT}) that is inversely proportional to temperature and that decreases as the temperature rises. The semiconductor device 100 generates a temperature-independent reference voltage (Vref) at reference voltage node 150 based on the PTAT voltage (V_{PTAT}) and the CTAT voltage (V_{CTAT}) (e.g., by combining those values) to produce, in some examples, a reference voltage, e.g., about 0.1V to about 0.5V, that is substantially zero temperature coefficient, e.g., less than 100 ppm/° C.

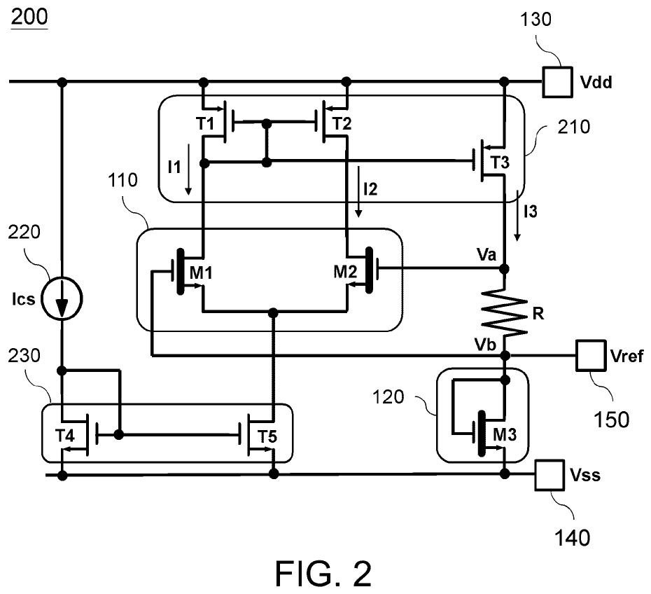

Example supporting circuitry for the semiconductor device 100 is depicted in FIG. 2. It is understood that this circuitry is provided by way of example, not by limitation, and other suitable semiconductor device 100 circuitry are within the scope of the present disclosure. FIG. 2 is a schematic circuit diagram illustrating another exemplary semiconductor device 200 in accordance with various embodiments of the present disclosure. As illustrated in FIG. 2, the semiconductor device 200 is connected between first and second supply voltage (Vdd, Vss) nodes 130, 140 and includes a first current mirror circuit 210, a current source circuit 220, a second current mirror circuit 230, a first temperature-dependent voltage generator 110, a resistor (R), and a second temperature-dependent voltage generator 120. The first current mirror circuit 210 includes first, second, and third transistors (T1, T2, T3), e.g., field-effect transistors (FETs), each having source, drain, and gate terminals. The source terminals of the first, second, and third transistors (T1, T2, T3) are connected to each other and to the first supply voltage (Vdd) node 130. The gate terminals of first, second, and third transistors (T1, T2, T3) are connected to each other and to the drain terminal of the first transistor (T1).

The current source circuit 220 has a first current source terminal connected to the first supply voltage (Vdd) node 130 and generates a substantially constant current (Ics) regardless of variations in the resistance of the load or changes in the first supply voltage (Vdd).

The second current mirror circuit 230 includes fourth and fifth transistors (T4, T5), e.g., FETs, each having source, drain, and gate terminals. The gate terminal and the drain terminal of the fourth transistor (T4) are connected to each other and to the second current source terminal of the current source circuit 220. The source terminal of the fourth transistor (T4) and the source terminal of the fifth transistor (T5) are connected to each other and to the second supply voltage (Vss) node 140.

The first temperature-dependent voltage generator 110 is in the form of a PTAT circuit, generates a PTAT voltage, and includes first and second transistor modules (M1, M2), e.g., FET modules, each having source, drain, and gate terminals. The drain terminal of the first transistor module (M1) is connected to the drain terminal of the first transistor (T1). The gate terminal of the first transistor module (M1) is connected to the reference voltage (Vref) node 150. The drain terminal of the second transistor module (M2) is connected to the drain terminal of the second transistor (T2). The gate terminal of the second transistor module (M2) is connected to the drain terminal of the third transistor (T3). The source terminal of the first transistor module (M1) and the source terminal of the second transistor module (M2) are connected to each other and to the drain terminal of the fifth transistor (T5).

The resistor (R) is connected between the gate terminal of the first transistor module (M1) and the gate terminal of the second transistor module (M2).

The second temperature-dependent voltage generating circuit 120 is in the form of a CTAT circuit, generates a CTAT voltage, and includes a third transistor module (M3), e.g., an FET module, having source, drain, and gate terminals. The drain and gate terminals of the third transistor module (M3) are connected to each other and to the reference voltage (Vref) node 150. The source terminal of the third transistor module (M3) is connected to the second supply voltage (Vss) node 140.

In operation, the semiconductor device 200 receives the first and second supply voltages (Vdd, Vss). Consequently, The first, second, and third transistors (T1, T2, T3) generate first, second, and third mirror currents (I1, I2, I3), respectively. There currents (I1, I2, I3) flow through the first and second transistor modules (M1, M2) and a node between the gate of the second transistor module (M2) and the resistor (R). The first and third mirror currents (I1, I3) are proportional to the second mirror current (I2). In this exemplary embodiment, the first, second, and third transistors (T1, T2, T3) have substantially the same property, such as W/L ratio, and thus the first, second, and third mirror currents (I1, I2, I3) are substantially equal to each other.

Subsequently, the current source circuit 220 generates a substantially constant current (Ics) that flows through the fourth transistor (T4) and that is mirrored at the fifth transistor (T5), thereby biasing the first and second transistor modules (M1, M2). As a result, the first temperature-dependent voltage generator 110 generates a PTAT voltage. At this time, the resistor generates a PTAT current that is substantially equal to a voltage drop (Va−Vb) across the resistor (R) divided by the resistance of the resistor (R) and that flows through the third transistor module (M3). As a result, the second temperature-dependent voltage generator 120 generates generate a CTAT voltage, whereby a temperature-independent reference voltage (Vref) is established at the reference voltage (Vref) node 150.

FIG. 3 is a schematic circuit diagram illustrating an exemplary transistor module (M1, M2, M3) of the semiconductor device 200 in accordance with various embodiments of the present disclosure. As illustrated in FIG. 3, the example transistor module (M1, M2, M3) includes a transistor stack (M1′, M2′, M3′). The transistor stack (M1′) includes a predetermined number of transistors, e.g., FETs, connected in series and each having source, drain, and gate terminals, connected in series. That is, the drain of the first transistor in the transistor stack (M1′) serves as the drain terminal of the transistor module (M1). Moreover, the source terminal of the last transistor in the transistor stack (M1′) serves as the source terminal of the transistor module (M1). In addition, the source terminal of each transistor in the transistor stack (M1) is connected to the drain terminal of the next transistor in the transistor stack (M1). The gate terminals of the transistors of the transistor stack (M1′) are connected to each other.

Likewise, the transistor stack (M2′) includes a predetermined number of transistors, e.g., FETs, connected in series and each having source, drain, and gate terminals. That is, the drain of the first transistor in the transistor stack (M2′) serves as the drain terminal of the transistor module (M2). Similarly, the source terminal of the last transistor in the transistor stack (M2′) serves as the source terminal of the transistor module (M2). In addition, the source terminal of each transistor in the transistor stack (M2) is connected to the drain terminal of the next transistor in the transistor stack (M2). The gate terminals of the transistors of the transistor stack (M2′) are connected to each other.

In this exemplary embodiment, the number of the transistors of the transistor stack (M2′) is greater than the number of the transistors of the transistor stack (M1′). In other words, the transistor module (M2) has a longer channel length than the transistor module (M1).

Similarly, the transistor stack (M3′) includes a plurality of transistors, e.g., FETs, connected in series and each having source, drain, and gate terminals. That is, the drain of the first transistor in the transistor stack (M3′) serves as the drain terminal of the transistor module (M3). Similarly, the source terminal of the last transistor in the transistor stack (M3′) serves as the source terminal of the transistor module (M3). In addition, the source terminal of each transistor in the transistor stack (M3) is connected to the drain terminal of the next transistor in the transistor stack (M3). The gate terminals of the transistors of the transistor stack (M3′) are connected to each other and to the drain terminal of the first transistor in the transistor stack (M3′).

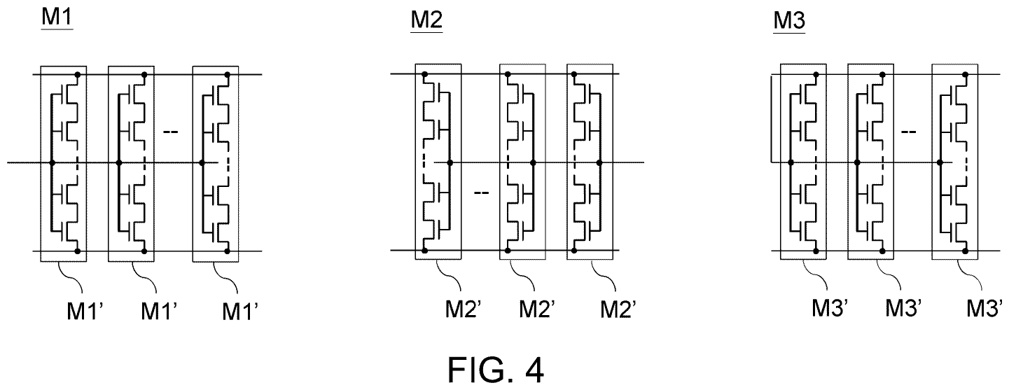

Although the transistor module (M1, M2, M3) is exemplified with only a single stack of transistors, it should be apparent that, after reading this disclosure, the transistor module (M1, M2, M3) may include one or more transistor stacks. For example, FIG. 4 is a schematic circuit diagram illustrating another exemplary transistor module (M1, M2, M3) of the semiconductor device 200 in accordance with various embodiments of the present disclosure. As illustrated in FIG. 4, the example transistor module (M1, M2, M3) includes a plurality of transistor stacks (M1′, M2′, M3′). The transistor stacks (M1′) are connected in parallel. For example, the drain terminals of the first transistors in the transistor stacks (M1′) are connected to each other. The source terminals of the last transistors in the transistor stacks (M1′) are connected to each other. The gate terminals of the transistors of the transistor stacks (M1′) are connected to each other.

Likewise, the transistor stacks (M2′) are connected in parallel. For example, the drain terminals of the first transistors in the transistor stacks (M2′) are connected to each other. The source terminals of the last transistors in the transistor stacks (M2′) are connected to each other. The gate terminals of the transistors of the transistor stacks (M2′) are connected to each other.

In this exemplary embodiment, the number of the transistor stacks (M2′) is the same as the number of the transistor stacks (M1′).

Similarly, the transistor stacks (M3′) are connected in parallel. For example, the drain terminals of the first transistors in the transistor stacks (M3′) are connected to each other. The source terminals of the last transistors in the transistor stacks (M3′) are connected to each other. The gate terminals of the transistors of the transistor stacks (M3′) are connected to each other and to the drain terminals of the first transistors in the transistor stacks (M3′).

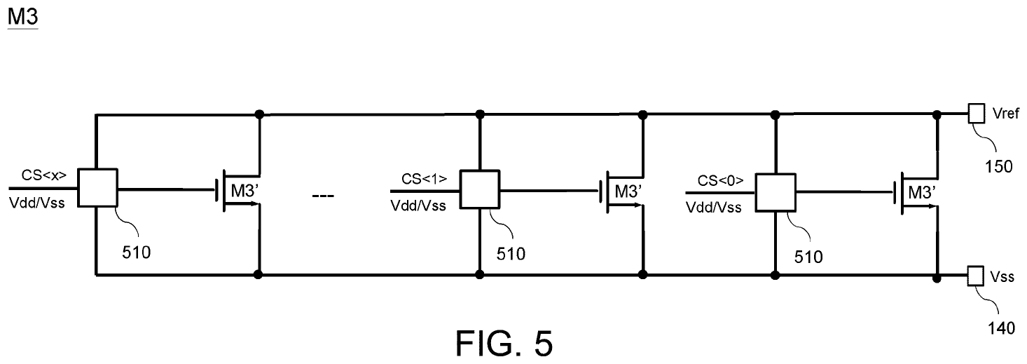

Although the transistor module (M1, M2, M3) is exemplified with a predetermined number of the transistor stacks (M1′, M2′, M3′), it should be apparent that, after reading this disclosure, the number of the transistor stacks (M1′ M2′, M3′) may be varied to better align the PTAT voltage/current generated by the first temperature-dependent voltage generator 110 and the CTAT voltage/current generated by the second temperature-dependent voltage generator 120 with each other. Such adjustment of the number of transistor stacks (M1′ M2′, M3′) facilitates a more stable temperature-independent reference voltage (Vref) for the semiconductor device 200 of the present disclosure. For example, FIG. 5 is a schematic circuit diagram illustrating another exemplary transistor module (M3) of the semiconductor device 200 in accordance with various embodiments of the present disclosure.

As illustrated in FIG. 5, the example transistor module (M3) includes a plurality of transistor stacks (M3′) and a plurality of switch circuits 510. The transistor stacks (M3′) are connected in parallel. For example, the transistor stack (M3′) has a drain terminal connected to the reference voltage (Vref) node 150 and a source terminal connected to the second supply voltage (Vss) node 140.

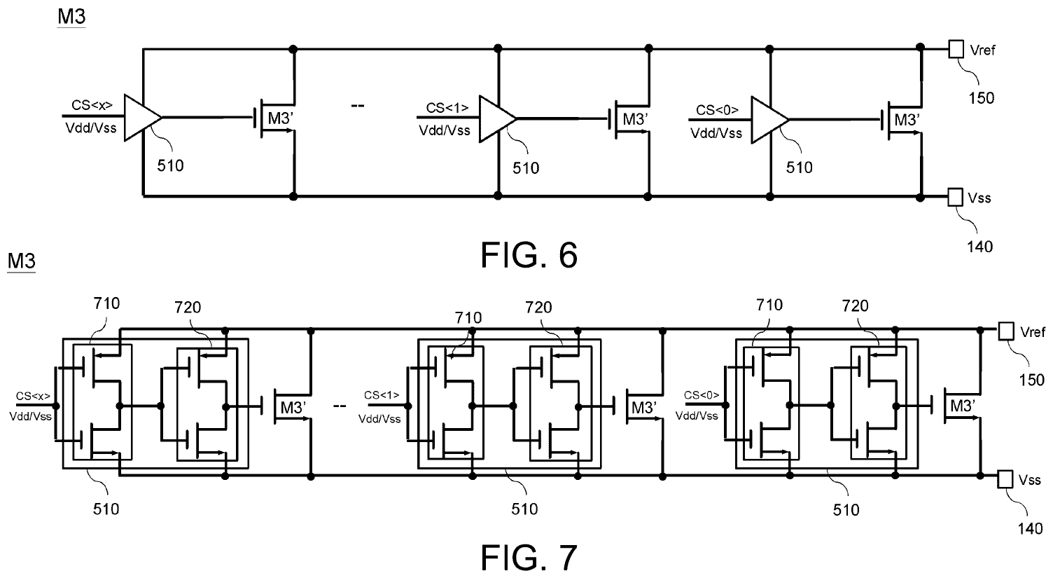

The semiconductor device 200 receives a plurality of control signals (CS<x:0>) from a control signal (CS<x:0>) generator external to the semiconductor device 200. Each of the switch circuits 510 receives a respective one of the control signals (CS<x:0>), a logical “1”, e.g., Vdd, or a logical “0”, e.g., Vss, and connects the gate terminal of a respective one of the transistor stacks (M3′) to either the reference voltage (Vref) node 150 or the second supply voltage (Vss) node 140 based on the control signal (CS<x:0>) received thereby. For example, FIGS. 6 and 7 are schematic circuit diagrams illustrating another exemplary transistor module (M3) of the semiconductor device 200 in accordance with various embodiments of the present disclosure.

As illustrated in FIG. 6, the switch circuit 510 is in the form of a buffer. The buffer 510 is connected between the reference voltage (Vref) node 150 and the second supply voltage (Vss) node 140 and includes an input terminal that receives the control signal (CS<x:0>) and an output terminal connected to the gate terminal of the transistor stack (M3′).

In this exemplary embodiment, as illustrated in FIG. 7, the buffer 510 includes a pair of inverters 710, 720, each connected between the reference voltage (Vref) node 150 and the second supply voltage (Vss) node 140. The inverter 710 has an input terminal that receives the control signal (CS<x:0>). The inverter 720 has an input terminal connected to the output terminal of the inverter 710 and an output terminal connected to the gate terminal of the transistor stack (M3′). In the exemplary embodiment, each inverter 710, 720 includes a p-type metal-oxide-semiconductor (PMOS) transistor and an n-type metal-oxide-semiconductor (NMOS) transistor.

In operation, when the control signal (CS<x:0>) is a logical “1”, e.g., Vdd, the PMOS and NMOS transistors of the inverter 710 are deactivated and activated, respectively, connecting the input terminal of the inverter 720 to the second supply voltage (Vss) node 140. This activates the PMOS transistor of the inverter 720 and substantially simultaneously deactivates the NMOS transistor of the inverter 720, connecting the gate terminal of the transistor stack (M3′) to the reference voltage (Vref) node 150. This, in turn, activates the transistor stack (M3′).

Conversely, when the control signal (CS<x:0>) is a logical “0”, e.g., Vss, the PMOS and NMOS transistors of the inverter 710 are activated and deactivated, respectively, connecting the input terminal of the inverter 720 to the first supply voltage (Vdd) node 150. This deactivates the PMOS transistor of the inverter 720 and substantially simultaneously activates the NMOS transistor of the inverter 720, connecting the gate terminal of the transistor stack (M3′) to the second supply voltage (Vss) node 140. This, in turn, deactivates the transistor stack (M3′).

From the foregoing, by activating and deactivating the transistor stacks (M3′) based on the control signals (CS′<x:0>), the number of the transistor stacks (M3′) of the transistor module (M3) connected between the reference voltage (Vref) node 150 and the second supply voltage (Vss) node 140 can be adjusted or fine-tuned.

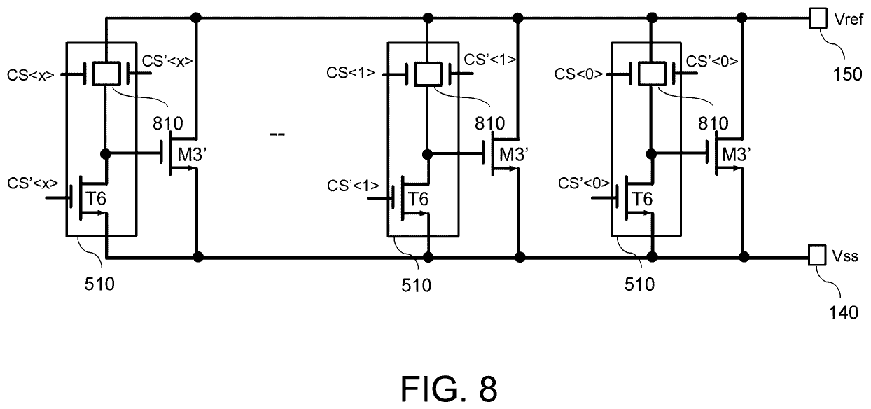

FIG. 8 is schematic circuit diagram illustrating another exemplary transistor module (M3) of the semiconductor device 200 in accordance with various embodiments of the present disclosure. As illustrated in FIG. 8, the switch circuit 510 includes a transmission gate 810 connected between the reference voltage (Vref) node 150 and the gate terminal of the transistor stack (M3′) and a sixth transistor (T6) connected between the gate terminal of the transistor stack (M3′) and the second supply voltage (Vss) node 140. The transmission gate 810 has a first input terminal that receives a control signal (CS<x:0>) and a second input terminal that receives a complement control signal (CS′<x:0>).

In this exemplary embodiment, the transistor (T6) is an NMOS transistor and has a drain terminal connected to the gate terminal of the transistor stack (M3′), a source terminal connected to the second supply voltage (Vss) node 140, and a gate terminal that receives the complement control signal (CS′<x:0>). In an alternative embodiment, the transistor (T6) is a PMOS transistor.

In operation, when the control signal (CS<x:0>) is a logical “1”, e.g., Vdd, i.e., the complement control signal (CS′<x:0>) is a logical “0”, e.g., Vss, the transmission gate 810 connects the gate terminal of the transistor stack (M3′) to the reference voltage (Vref) node 150. This turns the transistor stack (M3′) on. At this time, the transistor (T6) is turned off.

Conversely, when the control signal (CS<x:0>) is a logical “0”, e.g., Vss, i.e., the complement control signal (CS′<x:0>) is a logical “1”, e.g., Vdd, the transmission gate 810 disconnects the gate terminal of the transistor stack (M3′) from the reference voltage (Vref) node 150. At this time, the transistor (T6) is turned on, connecting the gate terminal of the transistor stack (M3′) to the second supply voltage (Vss) node 140. This turns the transistor stack (M3′) off.

From the foregoing, by turning the transistor stacks (M3′) on and off based on the control signals (CS′<x:0>), the number of the transistor stacks (M3′) of the transistor module (M3) connected between the reference voltage (Vref) node 150 and the second supply voltage (Vss) node 140 can be adjusted or fine-tuned.

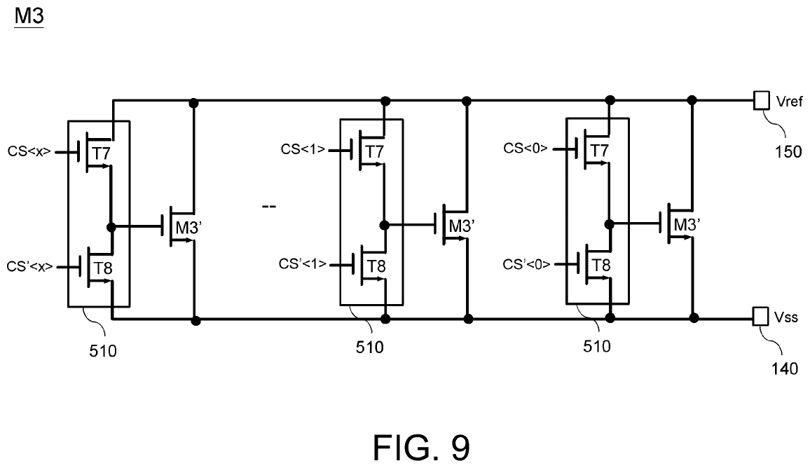

FIG. 9 is schematic circuit diagram illustrating another exemplary transistor module (M3) of the semiconductor device 200 in accordance with various embodiments of the present disclosure. As illustrated in FIG. 9, the switch circuit 510 includes seventh and eighth transistors (T7, T8) connected in series between the reference voltage (Vref) node 150 and the second supply voltage (Vss) node 140. In this exemplary embodiment, the seventh transistor (T7) is an NMOS transistor and has a drain terminal connected to the reference voltage (Vref) node 150, a source terminal connected to the gate terminal of the transistor stack (M3′), and a gate terminal that receives a control signal (CS<x:0>). The eighth transistor (T8) is an NMOS transistor and has a drain terminal connected to the gate terminal of the transistor stack (M3′), a source terminal connected to the second supply voltage (Vss), and a gate terminal that receives a complement control signal (CS′<x:0>). In an alternative embodiment, at least one of the first and second transistors (T7, T8) is a PMOS transistor.

In operation, when the control signal (CS<x:0>) is a logical “1”, e.g., Vdd, i.e., the complement control signal (CS′<x:0>) is a logical “0”, e.g., Vss, the seventh transistor (T7) is turned on, whereas the eighth transistor (T8) is turned off. This connects the gate terminal of the transistor stack (M3′) to the reference voltage (Vref) node 150 and substantially simultaneously disconnects the gate terminal of the transistor stack (M3′) from the second supply voltage (Vss) node 140, turning the transistor stack (M3′) on.

Conversely, when the control signal (CS<x:0>) is a logical “0”, e.g., Vss, i.e., the complement control signal (CS′<x:0>) is a logical “1”, e.g., Vdd, the seventh transistor (T7) is turned off, whereas the eighth transistor (T8) is turned on. This disconnects the gate terminal of the transistor stack (M3′) from the reference voltage (Vref) node 150 and substantially simultaneously connects the gate terminal of the transistor stack (M3′) to the second supply voltage (Vss) node 140, turning the transistor stack (M3′) off.

From the foregoing, by turning the transistor stacks (M3′) on and off based on the control signals (CS′<x:0>), the number of the transistor stacks (M3′) of the transistor module (M3) connected between the reference voltage (Vref) node 150 and the second supply voltage (Vss) node 140 can be adjusted or fine-tuned.

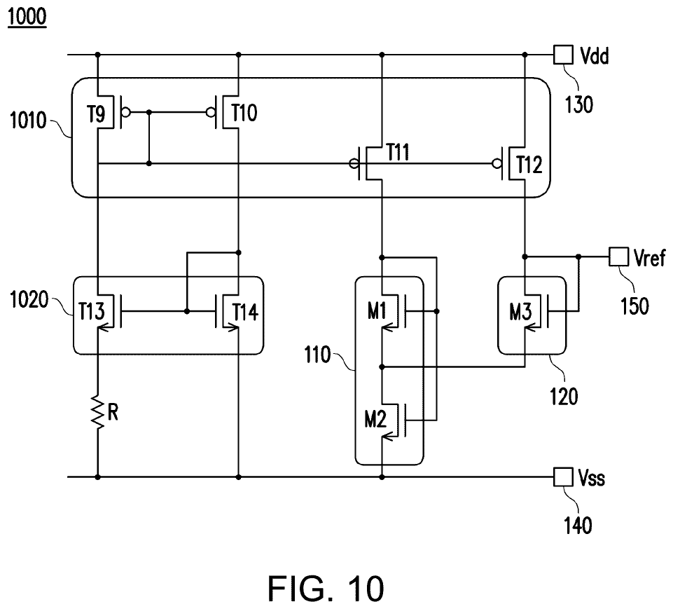

FIG. 10 is a schematic circuit diagram illustrating another exemplary semiconductor device 1000 in accordance with various embodiments of the present disclosure. As illustrated in FIG. 10, the semiconductor device 1000 is connected between the first and second supply voltage nodes 130, 140 and includes a first current mirror circuit 1010, a second current mirror circuit 1020, a resistor (R), a first temperature-dependent voltage generator 110, and a second temperature-dependent voltage generator 120. The first current mirror circuit 1010 includes transistors (T9-T12), e.g., FETs, each having source, drain, and gate terminals. The source terminals of the transistors (T9-T12) are connected to each other and to the first supply voltage (Vdd) node 130. The gate terminals of transistors (T9-T12) are connected to each other and to the drain terminal of the transistor (T9).

The second current mirror circuit 1020 includes transistors (T13, T15), e.g., FETs, each having source, drain, and gate terminals. The drain terminal of the transistor (T13) is connected to the drain terminal of the transistor (T9). The gate and drain terminals of the transistor (T14) and the gate terminal of the transistor (T13) are connected to each other and to the drain terminal of the transistor (T10). The source terminal of the transistor (T14) is connected to the second supply voltage (Vss) node 140.

The resistor (R) has a first resistor terminal connected to the source terminal of the transistor (T13) and a second resistor terminal connected to the second supply voltage (Vss) node 140.

The first temperature-dependent voltage generator 110 includes transistor modules (M1, M2), e.g., FET modules, each having source, drain, and gate terminals. The drain and gate terminals of the transistor module (M1) and the gate terminal of the transistor module (M2) are connected to each other and to the drain terminal of the transistor (T11). The source terminal of the transistor module (M2) is connected to the second supply voltage (Vss) node 140.

The second temperature-dependent voltage generating circuit 120 includes a transistor module (M3), e.g., an FET module, having source, drain, and gate terminals. The drain and gate terminals of the transistor module (M3) and the drain terminal of the transistor (T12) are connected to each other and to the reference voltage (Vref) node 150. The source terminal of the transistor module (M3) is connected to the source terminal of the transistor module (M1) and the drain terminal of the transistor module (M2).

Because the construction and operation of the transistor module (M1, M2, M3) of the semiconductor 1000 are similar to those described above in connection with the transistor module (M1, M2, M3) of the semiconductor device 200, a detailed description of the same will be dispensed with herein for the sake of brevity.

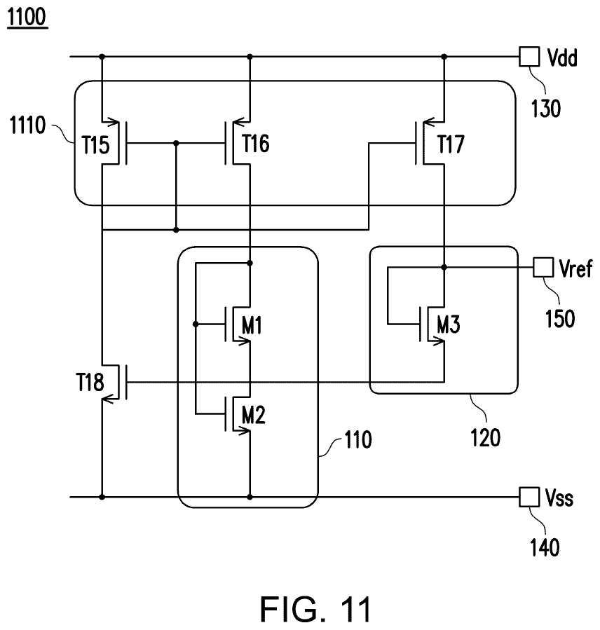

FIG. 11 is a schematic circuit diagram illustrating another exemplary semiconductor device 1100 in accordance with various embodiments of the present disclosure. As illustrated in FIG. 11, the semiconductor device 1100 is connected between the first and second supply voltage nodes 130, 140 and includes a current mirror circuit 1110, a transistor (T18), a first temperature-dependent voltage generator 110, and a second temperature-dependent voltage generator 120. The current mirror circuit 1110 includes transistors (T15-T17), e.g., FETs, each having source, drain, and gate terminals. The source terminals of the transistors (T15-T17) are connected to each other and to the first supply voltage (Vdd) node 130. The gate terminals of transistors (T15-T17) are connected to each other and to the drain terminal of the transistor (T15).

The transistor (T18), e.g., a FET, has source, drain, and gate terminals. The drain terminal of the transistor (T18) is connected to the drain terminal of the transistor (T15). The source terminal of the transistor (T18) is connected to the second supply voltage (Vss) node 140.

The first temperature-dependent voltage generator 110 includes transistor modules (M1, M2), e.g., FET modules, each having source, drain, and gate terminals. The drain and gate terminals of the transistor module (M1) and the gate terminal of the transistor module (M2) are connected to each other and to the drain terminal of the transistor (T16). The source terminal of the transistor module (M2) is connected to the second supply voltage (Vss) node 140.

The second temperature-dependent voltage generating circuit 120 includes a transistor module (M3), e.g., an FET module, having source, drain, and gate terminals. The drain and gate terminals of the transistor module (M3) and the drain terminal of the transistor (T17) are connected to each other and to the reference voltage (Vref) node 150. The source terminal of the transistor module (M3) is connected to the gate terminal of the transistor (T18), the source terminal of the transistor module (M1), and the drain terminal of the transistor module (M2).

Because the construction and operation of the transistor module (M1, M2, M3) of the semiconductor 1100 are similar to those described above in connection with the transistor module (M1, M2, M3) of the semiconductor device 200, a detailed description of the same will be dispensed with herein for the sake of brevity.

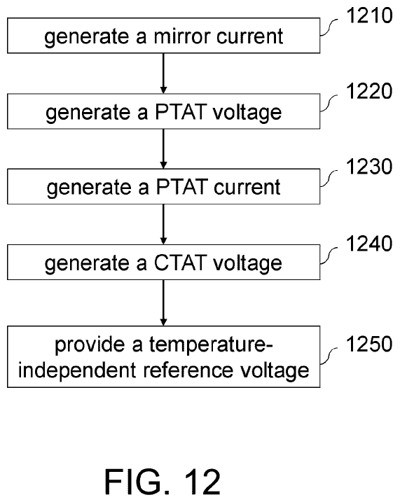

FIG. 12 is a flow chart of an exemplary embodiment of a method 1200 for generating a temperature-independent reference voltage (Vref) in accordance with various embodiments of the present disclosure. The example method 1200 will now be described with further reference to FIGS. 2-5 for ease of understanding. It is understood that the method 1200 is applicable to structures other than those of FIGS. 2-5. Further, it is understood that additional operations can be provided before, during, and after the method 1200, and some of the operations described below can be replaced or eliminated, in an alternative embodiment of the method 1200.

In operation 1210, the current mirror circuit 210 generates a first mirror current and a second mirror current substantially equal to the first mirror current.

In operation 1220, the first temperature-dependent voltage generator 110 generates a PTAT voltage based on the first and second mirror currents.

In operation 1230, the resistor generates a PTAT current.

In operation 1240, the second temperature-dependent voltage generator 120 generates a CTAT voltage based on the PTAT current. In certain embodiments, the second temperature-dependent voltage generator 120 includes a plurality of transistor stacks (M3′) and a plurality of switch circuits 510. In such certain embodiments, the transistor stacks (M3′) are connected in parallel. For example, the transistor stack (M3′) has a drain terminal connected to the reference voltage (Vref) node 150 and a source terminal connected to the second supply voltage (Vss) node 140. Each of the switch circuits 510 receives a respective one of control signals (CS<x:0>) and connects the gate terminal of a respective one of the transistor stacks (M3′) to either the reference voltage (Vref) node 150 or the second supply voltage (Vss) node 140 based on the control signal (CS<x:0>) received thereby.

In operation 1250, the reference voltage (Vref) node provides a temperature-independent reference voltage (Vref) based on the PTAT and CTAT voltages.

In an embodiment, a voltage generator comprises a temperature-dependent voltage generator and a reference voltage node. The temperature-dependent voltage generator generates a voltage that increases with temperature and includes a first transistor stack and a second transistor stack. Each of the first transistor stack and the second transistor stack has a predetermined number of transistors. The number of the transistors of the second transistor stack is greater than the number of the transistors of the first transistor stack. The reference voltage node is connected to the temperature-dependent voltage generator and provides a reference voltage substantially independent of temperature.

In another embodiment, a semiconductor device comprises a first temperature-dependent voltage generator, a second temperature-dependent voltage generator, and a reference voltage node. The first temperature-dependent voltage generator generates a voltage that increases with temperature. The second temperature-dependent voltage generator generates a voltage that decreases with temperature. The reference voltage node is connected to the first and second temperature-dependent voltage generators and provides a reference voltage substantially independent of temperature. The second temperature-dependent voltage generator includes a plurality of transistor stacks and a switch circuit configured to selectively connect one or more of the plurality of transistor stacks to the reference voltage node.

In another embodiment, a method for generating a temperature-independent reference voltage comprises: generating, by first and second transistor modules, a first temperature-dependent voltage that increases with temperature, wherein the second transistor module has a longer channel length than the second transistor module; generating, by a third transistor module, a second temperature-dependent voltage that decreases with temperature; and providing, at a reference voltage node, a temperature-independent reference voltage based on the first and second temperature-dependent voltages.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A voltage generator comprising:
a temperature-dependent voltage generator configured to generate a voltage that increases with temperature that includes a first transistor stack and a second transistor stack, each of the first transistor stack and the second transistor stack having a predetermined number of transistors, wherein the number of the transistors of the second transistor stack is greater than the number of the transistors of the first transistor stack; and
a reference voltage node connected to the temperature-dependent voltage generator and configured to provide a reference voltage substantially independent of temperature.

2. The voltage generator of claim 1, further comprising:
a first current mirror circuit configured to generate a first current and a second current proportional to the first current;
a second current mirror circuit configured to generate a third current and a fourth current proportional to the third current, wherein:
the first transistor stack has a first source/drain terminal connected to the first current mirror circuit, a second source/drain terminal connected to the second current mirror circuit, and a gate terminal connected to the reference voltage node; and
the second transistor stack has a first source/drain terminal connected to the first current mirror circuit, a second source/drain terminal connected to the second current mirror circuit, and a gate terminal connected to the first current mirror.

3. The voltage generator of claim 2, further comprising:
a supply voltage node configured to receive a supply voltage; and
a current source circuit configured to generate a substantially constant current and connected between the supply voltage node and the second current mirror circuit.

4. The voltage generator of claim 2, further comprising a resistor connected between the gate terminal of the first transistor stack and the gate terminal of the second transistor stack.

5. The voltage generator of claim 1, wherein the temperature-dependent voltage generator further includes one or more transistor stacks connected parallel to the first transistor stack.

6. The voltage generator of claim 1, wherein the temperature-dependent voltage generator further includes one or more transistor stacks connected parallel to the second transistor stack.

7. The voltage generator of claim 1, wherein the voltage generator has a temperature coefficient of less than 100 ppm/° C.

8. A semiconductor device comprising:
a first temperature-dependent voltage generator configured to generate a voltage that increases with temperature;
a second temperature-dependent voltage generator configured to generate a voltage that decreases with temperature; and
a reference voltage node connected to the first and second temperature-dependent voltage generators and configured to provide a reference voltage substantially independent of temperature, wherein the second temperature-dependent voltage generator includes:
a plurality of transistor stacks; and
a switch circuit configured to selectively connect one or more of the plurality of transistor stacks to the reference voltage node.

9. The semiconductor device of claim 8, further comprising:
a first current mirror circuit configured to generate a first current and a second current proportional to the first current;
a second current mirror circuit configured to generate a third current and a fourth current proportional to the third current, wherein:
the first transistor stack has a first source/drain terminal connected to the first current mirror circuit, a second source/drain terminal connected to the second current mirror circuit, and a gate terminal connected to the reference voltage node; and
the second transistor stack has a first source/drain terminal connected to the first current mirror circuit, a second source/drain terminal connected to the second current mirror circuit, and a gate terminal connected to the first current mirror.

10. The semiconductor device of claim 9, further comprising:
a supply voltage node configured to receive a supply voltage; and
a current source circuit configured to generate a substantially constant current and connected between the supply voltage node and the second current mirror circuit.

11. The semiconductor device of claim 9, further comprising a resistor connected between the gate terminal of the first transistor stack and the gate terminal of the second transistor stack.

12. The semiconductor device of claim 8, wherein the temperature-dependent voltage generator further includes a transistor stack connected parallel to the first transistor stack.

13. The semiconductor device of claim 8, wherein the temperature-dependent voltage generator further includes a transistor stack connected parallel to the second transistor stack.

14. The semiconductor device of claim 8, wherein the temperature-dependent voltage generator further includes:
one or more first transistor stacks connected parallel to the first transistor stack; and
one or more second transistor stacks connected parallel to the second transistor stack, wherein the number of the second transistors stacks is the same as the number of the first transistor stacks.

15. The semiconductor device of claim 8, further comprising a supply voltage node configured to receive a supply voltage, wherein the transistor stack has a first source/drain terminal and a gate terminal connected to each other and to the reference voltage node and a second source/drain terminal connected to the supply voltage node.

16. A method for generating a temperature-independent reference voltage, the method comprising:
generating, by first and second transistor modules, a first temperature-dependent voltage that increases with temperature, wherein the second transistor module has a longer channel length than the second transistor module;
generating, by a third transistor module, a second temperature-dependent voltage that decreases with temperature; and
providing, at a reference voltage node, a temperature-independent reference voltage based on the first and second temperature-dependent voltages.

17. The method of claim 16, further comprising:
generating a first mirror current that flows through the first transistor module;
generating a second mirror current that flows through the second transistor module proportional to the first mirror current; and
generating a temperature-dependent current that flows through the third transistor module.

18. The method of claim 16, further comprising:
generating a substantially constant current;
generating a third mirror current proportional to the substantially constant current; and
biasing the first and second transistor modules using the third mirror current.

19. The method of claim 16, further comprising generating a temperature-dependent current that flows through the third transistor module and that is based on a voltage drop across a resistor and a resistance of the resistor.

20. The method of claim 19, further comprising generating a mirror current that flows through the resistors.
